(19) United States
(12) Patent Application Publication
(10) Pub. No.: US 2009/0061368 A1
(43) Pub. Date: Mar. 5, 2009

(54) APPLIANCE HAVING LOAD MONITORING SYSTEM

(76) Inventors: Andrew Robert Caves, Milwaukee, WI (US); Andrew William Phillips, Columbia, SC (US); Brian Thomas Branecky, Oconomowoc, WI (US); William Louis Mehlhorn, Menomonee Falls, WI (US); Thomas Gerard Van Sistine, Menomonee Falls, WI (US); John Matthew Schulz, Franklin, TN (US)

Correspondence Address: MICHAEL BEST & FRIEDRICH LLP, 100 E WISCONSIN AVENUE, Suite 3300, MILWAUKEE, WI, 53202, US

(21) Appl. No.: 12/021,406

(22) Filed: Jan. 29, 2008

Related U.S. Application Data
(60) Provisional application No. 60/968,424, filed on Aug. 28, 2007.

(51) Int. Cl. F23N 5/00; F24B 1/18; G08B 21/00

(52) U.S. Cl. 431/66; 126/512; 340/657

(57) ABSTRACT

An appliance is disclosed that includes an electrically operated load such as a gas-fired appliance having an electrically operated gas valve. A current sensing circuit is configured to sense the current provided to the load. Based upon this sensed current, it is determined whether the load is energized. Methods are also disclosed for monitoring the status of a current sensing circuit to determine the actual operating state of the load.

### RELATED APPLICATIONS

This patent application claims the benefit of U.S. provisional patent application No. 60/968,424, filed on Aug. 28, 2007, the entirety of which is hereby incorporated by reference. This patent application also incorporates by reference the entire contents of co-pending U.S. patent application No. ______, filed on ______, 2008, entitled “APPLIANCE HAVING A SAFETY STRING” (Attorney Docket No. 010121-8164-00).

### FIELD OF THE INVENTION

The invention relates generally to appliances, such as gas-fired appliances, and more particularly to monitoring the operation of a load in the appliance, such as a gas valve.

### BACKGROUND

Control systems are known that include one or more switch units that are used to operate a load by controlling the supply of electrical power to the load. For example, gas-fired appliances are known to utilize a valve for controlling the release of gas to fuel a flammable heat source. Some such gas valves can be operable in response to an electrical current delivered from a power source.

### SUMMARY

Some embodiments of the invention provide a gas-fired appliance including an electrically-operated gas valve. The gas valve is coupled to a power source. A current sensing circuit is configured to sense a current through the gas valve. A controller monitors the current sensing circuit and determines whether the gas valve is open based upon the sensed current.

In some embodiments, the current sensing circuit includes a resistor. The voltage across the resistor is indicative of the current through the gas valve. The controller monitors the current sensing circuit by monitoring the voltage across the resistor.

In some embodiments, the gas-fired appliance includes a controller and at least one switch configured to reduce current from the power source to the gas valve when the at least one switch is open. In at least one embodiment, the controller is configured to determine an anticipated operating state of the gas valve based on the status of the at least one switch. The controller indicates an error condition if the anticipated operating state is not substantially the same as the actual operating state, as indicated by the current sensing circuit.

Some embodiments of the invention provide methods of monitoring a gas valve in a gas-fired appliance. A value is received that is indicative of the current sensed by the current sensing circuit and an actual operating state of the gas valve is determined based upon that value. In at least one embodiment, this actual operating state is compared to an anticipated operating state as indicated by the status of at least one switch.

Some embodiments provide a gas valve power checking circuit including a resistor having a relatively low resistance connected in series with the gas valve. A microcontroller, or other programmable device (e.g., microprocessor, digital signal processor, etc.) detects the voltage drop across the resistor when power is applied to the gas valve and determines if the power is greater than a threshold.

Some embodiments of the invention provide a system including an electrically-operated load. The load is coupled to a power source. A current sensing circuit is configured to sense a current through the load. A controller monitors the current sensing circuit and determines whether the load is energized based upon the sensed current.

### BRIEF DESCRIPTION OF DRAWINGS

FIG. 1 is a block diagram of one construction of a gas-fired water heater.

FIG. 2 is a schematic representation of one construction of a control system for the gas-fired water heater in FIG. 1.

FIG. 3 is a schematic representation of one construction of a monitored gas valve and associated monitoring circuitry capable of being used in the gas water heater of FIG. 1.

FIG. 4 is a schematic representation of one construction of a current sensing circuit capable of being used in the monitoring system of FIG. 3.

FIG. 5 is an operational flow of a controller monitoring the system of FIG. 3 while attempting to open the gas valve.

FIG. 6 is an operation flow of a controller monitoring the system of FIG. 3 while attempting to close the gas valve.

FIG. 7 is a schematic representation of a safety limit string and associated monitoring circuitry capable of being used in the system of FIG. 3.

FIG. 8 is a functional illustration showing the flow of current in the safety limit string of FIG. 7, where all switches in the safety limit string are closed.

FIG. 9 is a functional illustration showing the flow of current in the safety limit string of FIG. 7, where multiple switches in the safety limit string are open.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purposes of description and should not be regarded as limiting. The use of “including,” “comprising,” or “having” and variations thereof herein are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

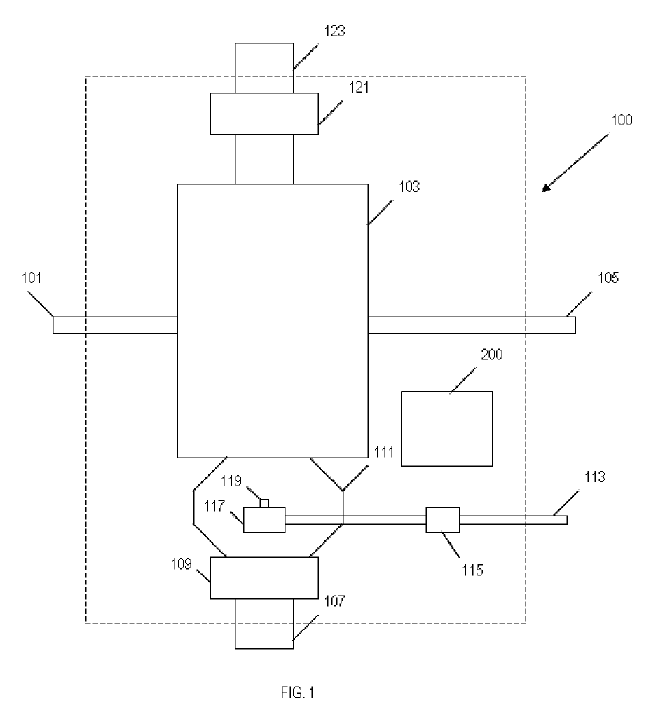

FIG. 1 shows one construction of a gas-fired water heater 100. Water heater 100 includes inlet pipe 101, which supplies unheated water to tank 103, and outlet pipe 105, which removes heated water from tank 103. Igniter 119 ignites gas burner 117 in combustion chamber 111 to heat the water. Gas valve 115 controls the flow of gas from gas inlet pipe 113 to burner 117. Blower 109 provides air from air inlet pipe 107 to combustion chamber 111. Vent 121 subsequently releases the air through air outlet pipe 123. The operation of water heater 100 is monitored and controlled by control system 200.

Although the constructions referred to herein describe a gas-fired water heater, the invention could be embodied in other gas-fired appliances such as, for example, a boiler, a furnace, and an oven. Other constructions of the invention could also be embodied in non-gas-fired systems, such as an electric water heater, that include type of electric load other than an electrically operated gas valve.

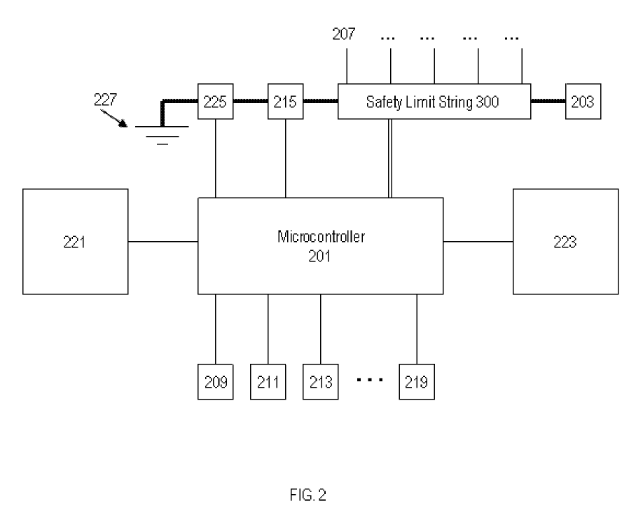

FIG. 2 shows one construction of control system 200 in greater detail. Microcontroller 201 is connected to user input device 221, user display/output device 223, electronically-controlled gas valve 215, and various other input sensors and controlled devices. Input sensors may include, for example, temperature sensor 209 which detects the temperature of the water in tank 103 and water level sensor 211 which detects the volume of water in tank 103. Controlled devices may include, for example, water pump 213 and igniter 219.

Safety limit string 300 is interposed between power source 203 and gas valve 215. Safety limit string 300 includes a plurality of normally open or normally closed switches arranged in series. All switches in safety limit string 300 should be closed before the gas valve can be sufficiently energized (i.e., opened). The switches are linked to various safety controls 207. Positioned between gas valve 215 and ground 227 is a current sensing circuit 225. When gas valve 215 is present, open, and operating properly, current from power source 203 flows through safety limit string 300 and current sensing circuit 225 on its way toward ground 227. Microcontroller 201 is configured to control gas valve 215 as well as monitor the status of switches in safety limit string 300 and current sensing circuit 225.

FIG. 3 illustrates the components of safety limit string 300 and the gas valve in more detail. Switches 301, 303, and 305 are responsive to conditions in the appliance; for example, switches 301, 303, and 305 could be pressure switches positioned to ensure proper blower air intake (blower 109) and exhaust pressures (vent 121). If a problem is detected (e.g., when a blower pressure is too low), one of the switches opens, power to the gas valve 215 is reduced, and the gas valve 215 closes. When switches 301, 303, and 305 are closed, current from power source 203 may travel to gas valve 215. The safety limit string 300 may contain more or less than the three switches shown in FIG. 3.

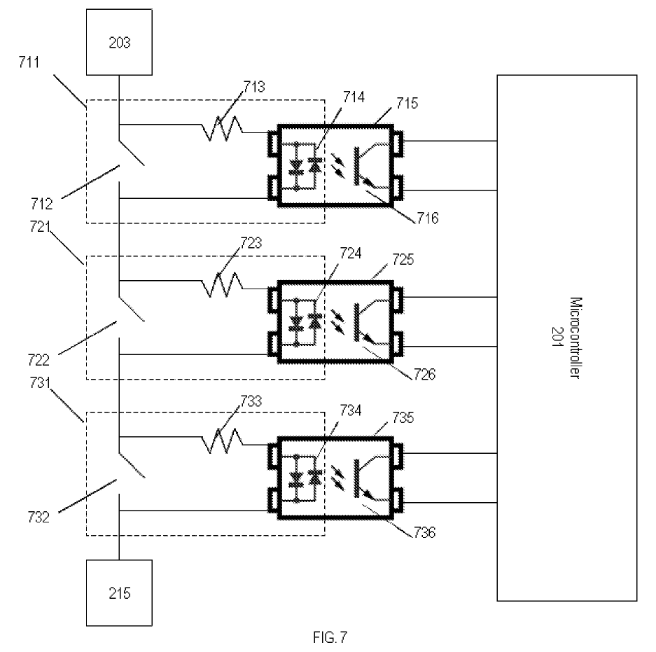

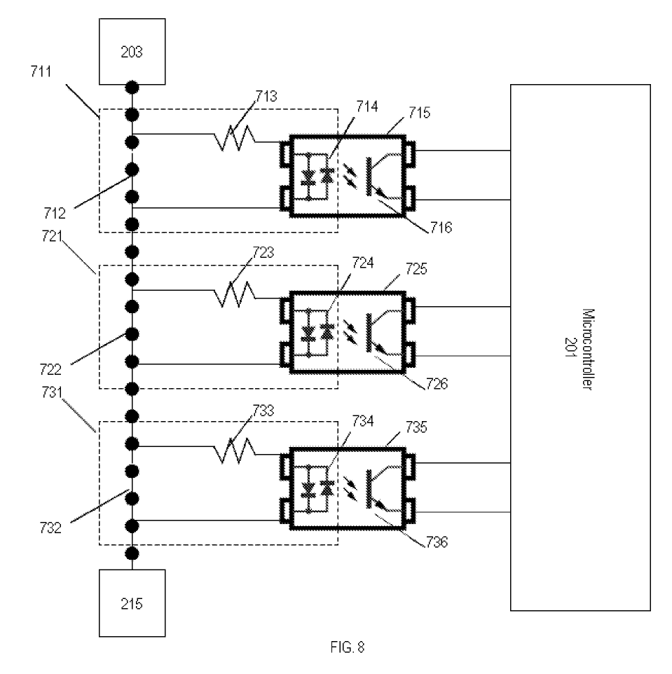

In the construction shown in FIG. 3, an open switch 301, 303, or 305 cuts off the supply of power from power supply 203 to gas valve 215. Microcontroller 201 (as pictured in FIG. 2) can detect an open switch in safety limit string 300 by monitoring status lines 307, 309, and 311. For example, if current is detected at status line 307, but not at status line 309, microcontroller 201 concludes that switch 301 is closed and switch 303 is open. Similarly, if current is detected at status lines 307 and 309, but not at status line 311, microcontroller 201 concludes that switch 301 and 303 are closed while switch 305 is open. Other systems may be implemented to monitor the status of the switches in safety limit string 300 including the arrangement discussed below and illustrated in FIGS. 7-9.

Gas valve relay 313 is a switch operable by microcontroller 201 through control line 315. Microcontroller 201 can control the operation of gas valve 215 by opening and closing gas valve relay 313. Like switches 301, 303, and 305 in safety limit string 300, if microcontroller 201 opens gas valve relay 313, gas valve 215 is disconnected from power supply 203 and does not open. Conversely, if microcontroller 201 closes gas valve relay 313 and all switches in safety limit string 300 are also closed, gas valve 215 receives sufficient power from power supply 203 and opens, thereby releasing gas to fuel the burner 117.

Current sensing circuit 225 is positioned and configured to detect current between gas valve 215 and ground 227. If switches 301,303, and 305 and gas valve relay 313 are closed, current should be present between gas valve 215 and ground 227. If any switch in safety limit string 300 or gas valve relay 313 is open, the power to gas valve 215 should be either completely disconnected or significantly reduced depending upon the construction. Therefore, depending upon the construction, there should be either no current present between gas valve 215 and ground 227 or a significantly reduced current. Microcontroller 201 monitors current sensing circuit 225 through status line 317.

In alternative constructions, current sensing circuit 225 might be positioned in other locations. For example, in some constructions, current sensing circuit 225 is positioned between gas valve relay 313 and gas valve 215 to sense the current provided to the gas valve. Other constructions may include two or more current sensing circuits 225 such as, for example, one positioned between the gas valve 215 and ground 227 and another positioned between gas valve relay 313 and gas valve 215.

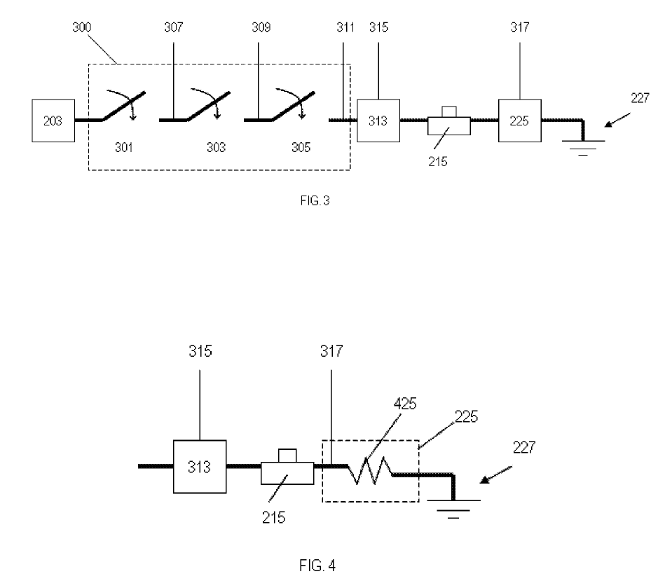

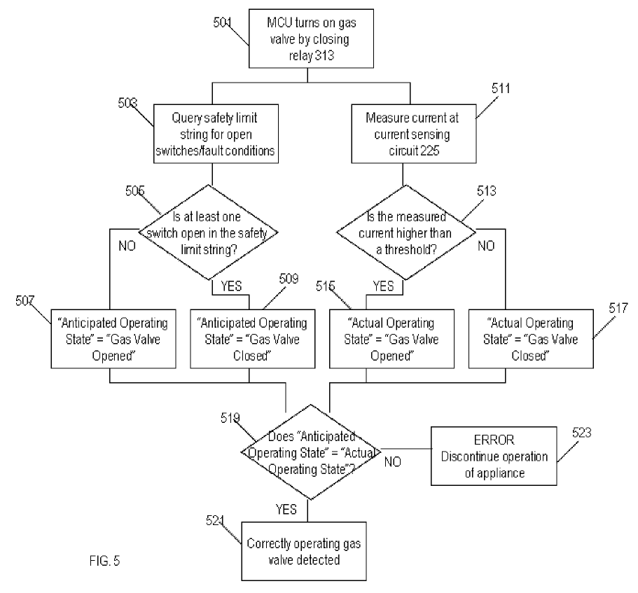

FIG. 4 is a schematic diagram illustrating one construction of current sensing circuit 225. A resistor 425 is positioned between gas valve 215 and ground 227. If current is present a voltage drop will be detected across resistor 425. Through status line 317, microcontroller 201 can monitor the voltage drop across resistor 425 and determine if the gas valve 215 is receiving sufficient power to operate. In this construction, the voltage across the resistor 425 is monitored by measuring the voltage relative to ground between the gas valve 215 and resistor 425. In other constructions, the voltage drop across resistor 425 may be monitored by calculating the difference in voltage measurements on either side of resistor 425. If the voltage drop is below a threshold, microcontroller 201 determines that there is a problem with the power being supplied to the gas valve 215. In some constructions, such as the construction of FIG. 3, an open switch in safety limit string 300 cuts off all current from power source 203 to gas valve 215. In such constructions, the threshold in this construction may be set slightly above zero amperes. The resistor 425 is chosen to have a relatively small resistance to ensure that there is enough power to open gas valve 215. Alternative constructions might include other current sensing devices, such as an optocoupler.

FIG. 5 demonstrates one method of monitoring gas valve 215 using the construction illustrated in FIG. 3. In this example, microcontroller 201 is attempting to open the gas valve 215 and ignite burner 117. Microcontroller 201 begins by closing relay 313 (step 501). Microcontroller 201 then determines an “anticipated operating state” based upon the status of the switches in the safety limit string 300 and an “actual operating state” based upon the status of current sensing circuit 225.

Microcontroller 201 monitors status lines 307, 309, and 311 to determine the status of the switches in safety limit string 300 (step 503). If status lines 307, 309, and 311 indicate that all switches in safety limit string 300 are closed, then a properly functioning gas valve 215 would be energized and opened. Therefore, the anticipated operating state of the gas valve 215 is that the gas valve 215 is opened (step 507). Conversely, if status lines 307, 309, and 311 indicate that at least one switch in safety limit string 300 is open (step 505), then a properly functioning gas valve 215 would be closed. In such a situation, the anticipated operating state of the gas valve 215 would be that the gas valve 215 is closed (step 509).

Microcontroller 201 monitors status line 317 to determine whether current is detected at current sensing circuit 225 and, therefore, gas valve 215 is opened. The current passing through current sensing circuit 225 is measured (step 511) and compared to a threshold (step 513). If the threshold is exceeded, microcontroller 201 concludes that the gas valve 215 is energized. Therefore, the actual operating state of the gas valve 215 is that gas valve 215 is opened (step 515). Conversely, if the threshold is not exceeded, microcontroller 201 concludes that the gas valve 215 is not energized. In such a situation, the actual operating state of the gas valve 215 is that gas valve 215 is closed (step 517).

Microcontroller 201 then compares the anticipated operating state to the actual operating state (step 519). If the two match, the microcontroller 201 concludes that gas valve 215 is installed and operating properly (step 521). However, if the two do not match, the microcontroller 201 concludes that gas valve 215 is either not installed or not operating properly. Microcontroller 201 will display an error message to user display/output device 223 and will not allow the appliance to fire (step 523).

The anticipated operating condition may not match the actual operating state if, for example, status lines 307, 309, and 311 indicate that all switches in the safety limit string 300 are closed, but no current is detected at current sensing circuit 225. In this situation, the closed switches in safety limit string 300 and gas valve relay 313 should connect gas valve 215 to power source 203; however, the lack of current detected at current sensing circuit 225 indicates that gas valve 215 is not energized and, therefore, closed. Such a condition might be caused, for example, by an improper short circuit between switch 305 and ground 227 bypassing gas valve 215 and current sensing circuit 225. Such a condition might also arise, for example, if gas valve 215 is not installed and, therefore, the circuit between power source 203 and ground 227 is not complete.

This may also occur if, for example, status line 309 indicates that switch 303 is open, but current is detected at current sensing circuit 225. In this situation, open switch 303 should have disconnected gas valve 215 from power source 203; however, the current detected at current sensing circuit 225 indicates that gas valve 215 is energized and, therefore, opened. Such a condition might be caused, for example, by an improper short circuit between the gas valve 215 and a power source.

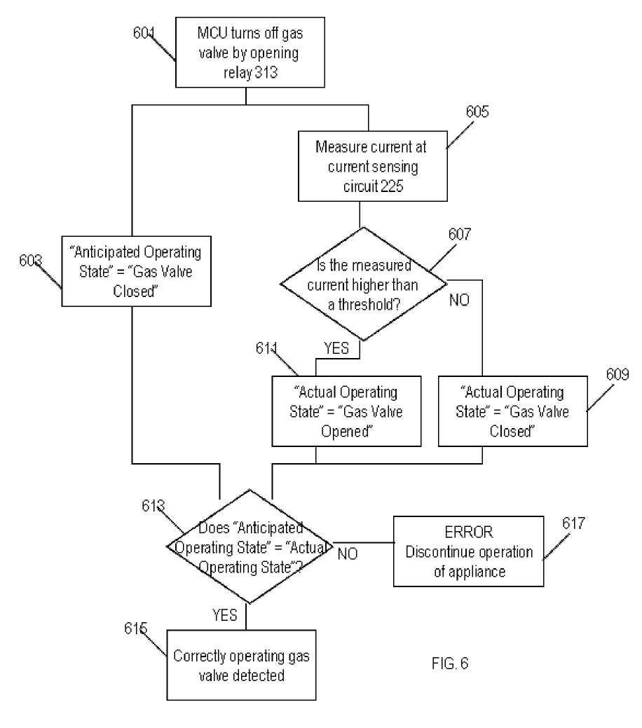

FIG. 6 demonstrates another method of monitoring gas valve 215 using the construction illustrated in FIG. 3. In this example, microcontroller 201 attempts to close the gas valve 215 and extinguish burner 117. Microcontroller 201 begins by opening relay 313 (step 601). Because gas valve relay 313 is opened, power supply 203 should be disconnected from gas valve 215. Therefore, the anticipated operating state of the gas valve 215 is that the gas valve 215 is closed (step 603).

Microcontroller 201 then determines the “actual operating state” of the gas valve 215 based upon the status of current sensing circuit 225. The current through current sensing circuit 225 is measured (step 605) and compared to a threshold (step 607). If the threshold is not exceeded, microcontroller 201 concludes that the gas valve 215 is not energized. Therefore, the actual operating state of the gas valve 215 is that gas valve 215 is closed (step 609). However, if the threshold is exceeded, microcontroller 201 concludes that the gas valve 215 is energized. In such a situation, the actual operating state of the gas valve 215 is that gas valve 215 is opened (step 611).

Microcontroller 201 then compares the anticipated operating state to the actual operating state (step 613). If the actual operating state is that the gas valve 215 is closed, the microcontroller 201 concludes that gas valve 215 is installed and operating properly (step 615). However, if the actual operating state is that gas valve 215 is open, the microcontroller 201 concludes that gas valve 215 is not operating properly. Microcontroller 201 will display an error message to user display/output device 223 and will not allow the appliance to fire (step 523). In this situation, the gas valve 215 might be opened, thereby causing a mismatch between the anticipated operating state and the actual operating state, if, for example, an improper short circuit has occurred between the gas valve 215 and a power source.

The functionality demonstrated in some of the steps of FIGS. 5 and 6 can be accomplished with a comparator circuit that provides a Boolean logic (high or low) signal to microcontroller 201 from current sensing circuit 225. However, alternative constructions that connect status line 317 to an analog-to-digital converter on microcontroller 201 allow for additional evaluation capabilities. The voltage drop across resistor 425 is proportional to the current traveling through resistor 425. Therefore, if the voltage of power source 203 is known, microcontroller 201 can evaluate the condition or presence of other components in the circuit based upon the resistance of the remaining circuit.

For example, if power source 203 is a 10 v power source, the resistance of resistor 225 is 1 ohm, and the resistance of the switches 301, 303, 305, and 313 are negligible, microcontroller 201 can determine the resistance of gas valve 215 based upon the voltage drop over resistor 225. In this example, a correctly installed gas valve 215 has a resistance of 9 ohms. Based upon this information, microcontroller 201 can conclude that the correct gas valve 215 is properly installed when 1 v is detected by the analog-to-digital converter at status line 317. Furthermore, the microcontroller can conclude that either gas valve 215 is improperly installed or an incorrect gas valve has been used if the voltage detected by the analog-to-digital converter at status line 217 is greater than or less than 1 v. The values used in this example are for illustrative purposes only and are not intended as limiting. Power source 203 may supply whatever voltage may be desired for the particular device (for example, 24 v). Similarly, the resistance of gas valve 215 and resistor 425 may be greater or lesser than 9 ohms and 1 ohm respectively.

Furthermore, although the functionality described in FIGS. 5 and 6 can be accomplished with the safety limit string 300 as described above and illustrated in FIG. 3, additional evaluation functionality may be implemented by constructing a safety limit string 300 that can communicate the status of each switch to microcontroller 201, regardless of the status of the preceding switches. FIG. 7 provides a more detailed view of one such construction of the safety limit string 300. A plurality of switching units (711, 721, and 731) are arranged in series between a 24 VAC power source 203 and a gas valve 215. Switching unit 711 includes two circuits arranged in parallel—a switch circuit and a leakage circuit. The switch circuit includes a switch 712 of relatively low resistance. The leakage circuit includes a resistor 713 having a relatively large resistance and the emitter of an optocoupler 715. The receiver of optocoupler 715 is connected to the microcontroller 201. Similar components in switching units 721 and 731 are labeled with similar reference characters.

An optocoupler (such as 715, 725, and 735) typically includes an emitter and a receiver. Referring to optocoupler 715 in FIG. 7, the emitter includes a light source such as LEDs 714. The receiver includes a light detector such as phototransistor 716. When current passes through the emitter, light is generated and detected by the receiver. Because the receiver is not electrically conductive to the emitter, the circuit containing the emitter is separate from the circuit including the receiver. By connecting microcontroller 201 to the receiver of optocoupler 715, microcontroller 201 can determine when current is passing through the emitter without interfering with the safety limit string 300. As discussed in detail below, this construction allows current to continue through subsequent switching units so that the microcontroller 201 is able to detect multiple open switches at the same time.

Because the switch circuit in this construction is significantly less resistant than the leakage circuit, little or no current flows through the leakage circuit if switch 712 is closed. Microcontroller 201 monitors optocoupler 715 and is configured to associate this condition with a closed switch 712. If switch 712 is open, current flows through the leakage circuit and the microcontroller 201 detects this current through optocoupler 715.

In some optocouplers (such as 715, 725, and 735), the amount of current detected on the receiver (e.g., the phototransistor 715) is proportional to the amount of current on the emitter (e.g., the LEDs 714); however, if the current on the emitter is below a certain threshold, no current is detected on the emitter. As such, in some constructions, components are selected such that when switch 712 is closed, no current is detected at optocoupler 715. In these constructions, the receiver of optocoupler 715 is connected to a digital input pin on microcontroller 201 and provides a high or low logic signal indicative of the status of switch 712.

In other constructions, the receiver of optocoupler 715 may detect a relatively small current even when switch 712 is closed. In such constructions, microcontroller 201 and associated circuitry on the receiver side of optocoupler 715 are configured to associate a current in excess of a predetermined threshold with an open switch. This comparison can be implemented by various methods including connecting the receiver of optocoupler 715 to a voltage or current comparator circuit that compares the detected current or voltage to a reference current or voltage. Such a comparator circuit is further configured to provide a high or low logic signal to microcontroller 201 indicative of the status of switch 712.

Alternatively, the receiver side of optocoupler 715 can be connected to an analog-to-digital converter on microcontroller 201. Microcontroller 201 can be configured to compare the value at the analog-to-digital converter to a predetermined threshold or can adaptively associate switches into “open” and “closed” groupings depending on the relative voltage or current detected at the corresponding optocoupler.

FIG. 7 shows an AC circuit construction in which optocoupler 715 includes two LEDs 714 (one for each direction in the alternating current) and a corresponding photodiode 716. Such optocoupler integrated circuits are commercially available in the PS2505 Multi Photocoupler Series produced by NEC Electronics, Inc. These components may include one or more optocouplers on the same IC. DC optocouplers are also available which include a single LED for each phototransistor. Still other optocoupler configurations utilize photodiodes instead of phototransistors.

In an example construction, switch 712 is a pressure switch monitoring air intake from blower 109, switch 722 is a pressure switch monitoring exhaust pressure from vent 121, and switch 732 is a bimetallic temperature switch configured to open if the temperature of the water in tank 103 exceeds a high-limit. It will be understood by those having ordinary skill in the art that safety limit string 300 may include various combinations of these and other switches and need not be assigned as in this construction.

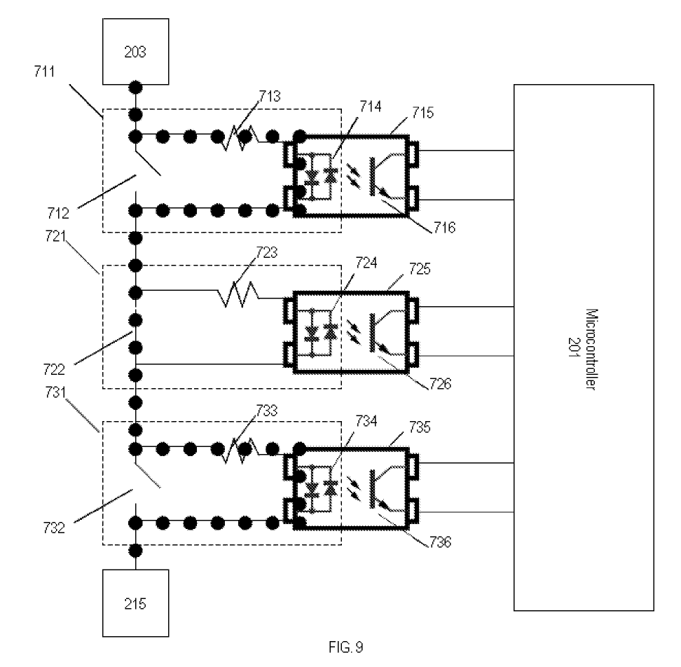

FIG. 8 illustrates the current flow through safety limit string 300 when all switches are closed. The flow of current is represented by the heavy dotted line. When all switches in safety limit string 300 are closed, current flows from power source 203 through low resistance switches 712, 722, and 732 and provides enough power to open gas valve 215. In this condition, microcontroller 201 can regulate gas flow by opening or closing gas valve 215. Microcontroller 201 can also confirm correct operation of blower 109 and vent 121 by monitoring optocouplers 715 and 725 respectively and can verify that the high-limit temperature has not been exceeded by monitoring optocoupler 735.

FIG. 9 illustrates the current flow through safety limit string 300 when switch 722 is closed, but switches 712 and 732 are open. Resistors 713, 723, and 733 in this construction have a high enough resistance such that when any one switch in the safety limit string 300 is open, the current through safety limit string 300 is reduced and the power is insufficient to energize (i.e., open) gas valve 215. Conversely, resistors 713, 723, and 733 have a low enough resistance such that when all of the switches in the safety limit string 300 are open, enough power remains such that the microcontroller 201 can detect current at optocouplers 715, 725, and 735.

Current flows through the leakage circuit in switching unit 711 and is detected by microcontroller 201 through optocoupler 715. Microcontroller 201 is configured to associate this condition with an insufficient intake pressure from blower 109. Current continues to switching unit 721 and passes through the switch circuit. Little or no current is directed through the leakage circuit and, as such, is not detected by microcontroller 201 through optocoupler 725. Microcontroller 201 is configured to associate this condition with a sufficient exhaust pressure at vent 121. Current then passes through the leakage circuit of switching unit 731 and is detected by microcontroller 201 through optocoupler 735. Microcontroller 201 is configured to associate this condition with a water temperature in tank 103 that exceeds the high-limit threshold. Finally, current arrives at gas valve 215. However, resistors 713 and 733 have reduced the current such that the available power is insufficient to operate the gas valve 215. Consequently, gas valve 215 remains closed and microcontroller 201 is aware of the adverse safety conditions.

It should be understood that the constructions described above are exemplary and other configurations and designs are possible. For example, although the above constructions describe an AC circuit, DC circuits might also be constructed. Furthermore, terms such as “resistor” and “emitter” are used broadly. Unless otherwise specified, the term “resistor,” for example, may refer to a single discrete component or it may refer to an arrangement of multiple components that together introduce resistance into a circuit. As such, additional components may be added to the describe circuit constructions without departing from the intended scope. Likewise, unless otherwise specified, the term “emitter,” for example, may refer to any device that emits or communicates a signal.

Although some of the above examples include a gas-fired appliance such as a gas-fired water heater, the invention may be applied to other non-gas-fired systems unless explicitly stated otherwise. For example, the gas-fired water heater system as illustrated in FIG. 3 might be replaced with an electric water heater wherein gas valve 215 is replaced with an electric resistance coil. Various features and advantages of the invention are set forth in the following claims.

What is claimed is:

1. A gas-fired appliance comprising:
an electrically-operated gas valve coupled to a power source;
a current sensing circuit configured to sense a current through the gas valve; and
a controller configured to monitor the current sensing circuit and to determine whether the gas valve is opened based upon the sensed current.

2. The gas-fired appliance according to claim 1, further comprising a switch operable by the controller and configured to open the gas valve by allowing current to the gas valve and to close the gas valve by restricting current to the gas valve.

3. The gas-fired appliance according to claim 1, wherein the current sensing circuit includes a resistor and wherein the controller is configured to monitor the current sensing circuit by detecting a voltage across the resistor.

4. The gas-fired appliance according to claim 3, wherein the controller is further configured to
quantify the voltage across the resistor, and
associate the quantified voltage with an actual operating state of the gas valve.

5. The gas-fired appliance according to claim 1, further comprising a switch configured to reduce current from the power source to the gas valve when the switch is open.

6. The gas-fired appliance according to claim 5, wherein the switch is electrically connected between the power source and the gas valve, and wherein the current sensing circuit is electrically connected between the gas valve and ground.

7. The gas-fired appliance according to claim 5, wherein the controller is further configured to
determine an anticipated operating state of the gas valve based on the status of the switch;
determine an actual operating state of the gas valve based on the current sensed by the current sensing circuit; and
signal an error condition when the actual operating state and the anticipated operating state are not substantially the same.

8. The gas-fired appliance according to claim 1, further comprising:
a safety limit string including a plurality of switches, each responsive to an operating condition,
wherein the operating condition causes one of the plurality of switches to open to disconnect the power source from the gas valve, and
wherein the controller is further configured to associate an open switch from the safety limit string with an anticipated operating state of the gas valve.

9. The gas-fired appliance according to claim 1 further comprising:
a first switching unit including
a first switch circuit including a first switch responsive to a first condition in the appliance, and
a first leakage circuit electrically connected in parallel with the first switch circuit, the first leakage circuit comprising an emitter of a first optocoupler; and
a second switching unit electrically connected in series with the power source, the gas valve, and the first switching unit, the second switching unit including
a second switch circuit including a second switch responsive to a second condition in the appliance, and
a second leakage circuit electrically connected in parallel with the second switch circuit, the second leakage circuit comprising an emitter of a second optocoupler; and
wherein the controller is further configured to
detect a status of the first switch by monitoring a receiver of the first optocoupler,
detect a status of the second switch by monitoring a receiver of the second optocoupler, and
determine an anticipated operating state of the gas valve based on the status of the first switch and the status of the second switch.

10. The gas-fired appliance according to claim 9, wherein the controller is further configured to
determine an actual operating state of the gas valve based on the current sensed by the current sensing circuit; and
signal an error condition when the actual operating state and the anticipated operating state are not substantially the same.

11. A method of monitoring a gas valve in a gas-fired appliance, wherein the gas-fired appliance includes:
an electrically operated gas valve coupled to a power source;
a current sensing circuit configured to sense a current through the gas valve, the method comprising:
receiving a value indicative of the current sensed by the current sensing circuit; and
determining an actual operating state of the gas valve based on the value.

12. The method according to claim 11, wherein the gas-fired appliance further includes a switch configured to reduce current from the power source to the gas valve when the switch is open, the method further comprising:
determining an anticipated operating state of the gas valve based on the status of the switch; and
signaling an error condition when the actual operating state and the anticipated operating state are not substantially identical.

13. The method according to claim 12, further comprising indicating that the gas valve is operating correctly when the actual operating state and the anticipated operating state are substantially the same.

14. The method according to claim 12, further comprising indicating that a short circuit has occurred when the anticipated operating state indicates that the gas valve is closed and the actual operating state indicates that the gas valve is opened.

15. The method according to claim 12, further comprising indicating that the gas valve is not properly installed when the anticipated operating state indicates that the gas valve is opened and the actual operating state indicates that the gas valve is closed.

16. The method according to claim 12, further comprising indicating that the gas valve is damaged when the anticipated operating state indicates that the gas valve is opened and the actual operating state indicates that the gas valve is closed.

17. The method according to claim 11, wherein the current sensing circuit includes a resistor, the method further comprising:
measuring a voltage across the resistor, the voltage being proportional to the current through the gas valve;
and wherein determining the actual operating state of the gas valve includes:
comparing the measured voltage to a threshold indicative of an open gas valve.

18. The method according to claim 17, wherein determining an actual operating state of the gas valve further includes:
determining that the actual operating state of the gas valve includes the gas valve being open when the measured voltage is above the threshold.

19. The method according to claim 17, wherein determining an actual operating state of the gas valve further includes:
determining that the actual operating state of the gas valve includes the gas valve being closed when the measured voltage is below the threshold.

20. The method according to claim 11, wherein the gas-fired appliance further includes:
a first switching unit including
a first switch circuit including a first switch, and
a first leakage circuit electrically connect in parallel with the first switch circuit, the first leakage circuit including an emitter of a first optocoupler; and
a second switching unit electrically connected in series with the power source, the gas valve, and the first switching unit, the second switching unit including
a second switch circuit including a second switch, and
a second leakage circuit electrically connect in parallel with the second switch circuit, the second leakage circuit including an emitter of a second optocoupler,
the method further comprising:
detecting a status of the first switch by monitoring the first optocoupler;
detecting a status of the second switch by monitoring the second optocoupler; and
determining an anticipated operating state of the gas valve based on the status of the first switch and the status of the second switch.

21. A system comprising:
an electrically-operated load coupled to a power source;
a current sensing circuit configured to sense a current through the load;
a switch configured to reduce current from the power source to the load when the switch is open; and
a controller configured to monitor the current sensing circuit and to determine whether the load is energized based upon the sensed current.

22. The system according to claim 21, wherein the controller is further configured to
determine an anticipated operating state of the load based on the status of the switch;
determine an actual operating state of the load based on the current sensed by the current sensing circuit; and
signal an error condition when the actual operating state and the anticipated operating state are not substantially the same.
